(19) United States
(12) Patent Application Publication
(10) Pub. No.: US 2025/0335861 A1
(43) Pub. Date: Oct. 30, 2025

(54) OPERATIONAL RESILIENCE SCENARIO SIMULATION

(71) Applicant: Fusion Risk Management, Inc., Chicago, IL (US)

(72) Inventor: Robert Davis DeRodes, Morrisville, NC (US)

(73) Assignee: Fusion Risk Management, Inc., Chicago, IL (US)

(21) Appl. No.: 18/650,398

(22) Filed: Apr. 30, 2024

(51) Int. Cl. G06Q 10/067

(52) U.S. Cl. CPC G06Q 10/067

(57) ABSTRACT

Simulation for business continuity includes querying a scenario repository for a specific adverse event and responding to the query by selecting and retrieving from the repository infrastructure element objects that are associated with the specific adverse event. The simulation executes a Monte Carlo scenario test of the infrastructure element objects across a range of the susceptibility values through the computation of an average of the susceptibility values for each infrastructure element object for randomly selected different degrees of severity of the event. The simulation additionally executes a recovery simulation of the infrastructure element objects across a range of recovery times by computing an average recovery time for each infrastructure element object amongst the range of the recovery times. Finally, the simulation includes applying one or more loss value rules to the scenario tested and recovery simulated infrastructure element objects in order to produce a loss estimate for the target environment.

### BACKGROUND OF THE INVENTION

### Field of the Invention

The present invention relates to the technical field of business continuity management and more particularly to adverse incident scenario simulation in a business continuity computer management system.

### Description of the Related Art

Business continuity planning refers to the planning involved in a business organization addressing prospective adverse events so as to ensure the continuous operation of the organization during the course of such adverse events. Disaster recovery planning is an extension of business continuity planning in which mechanisms and requirements are specified in order to promote the recovery of an organization impacted by an adverse event. Historically, both business continuity planning and disaster recovery planning have been manually processes performed by a team of analysts crafting and completing spreadsheet-like what-if analyses in regard to different disaster scenarios imagined by the planning team. As well, scenario table-top simulations have proven helpful in assessing impact tolerance—the likelihood of an adverse event resulting in irreparable harm to an entity such as an organization, a customer, or even local, regional or national economy.

More recently, however, much of business continuity planning has been automated. In this regard, automated business continuity and disaster recovery planning tools tap information in a database cataloging different organizational assets with different exposures to different adverse events and process those assets against a specified scenario involving one or more of the adverse events. This processing generally results in the production of a manifest of assets exposed to the one or more adverse events of the specified scenario. The manifest, in turn, may be processed against pre-stored data in order to enumerate a cost of the impact of the one or more of the adverse events upon the assets of the manifest, and a time required to return those of the impacted assets to nominal operating condition. As such, a team reviewing the automated analysis can simulate an improvement in preparedness for the scenario by modifying the characterization of one or more of the assets in the manifest in order to lower the cost of impact, reduce the time required to return the impacted assets to nominal operating condition, or both.

Central to scenario simulation is the determination of a time period required for recovery from the occurrence of an adverse event and a cost of recovering by the conclusion of the time period. However, in reality, the occurrence of an adverse event alone is insufficient alone for business continuity planning because the adverse event can occur at different levels of severity resulting in different time periods for recovery at different costs. As well, some degree of impedance of the operation of an organizational asset may be acceptable when comparing the cost of impedance to the cost of immunizing the organizational asset from the occurrence of the adverse event.

### BRIEF SUMMARY OF THE INVENTION

Embodiments of the present invention address technical deficiencies of the art in respect to business continuity management. To that end, embodiments of the present invention provide for a novel and non-obvious method for business continuity simulation. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a simulation method for business continuity includes establishing a communicative linkage over a computer communications network to a scenario repository that stores therein different infrastructure element objects for a target environment. Each of the objects encapsulates both susceptibility values for different adverse events for different degrees of severity of respective ones of the different adverse events, and also recovery times for the different adverse events for the different degrees of severity of the respective ones of the different adverse events. The method additionally includes querying the scenario repository for a specific one of the adverse events and retrieving in response to the querying, a selection of the infrastructure element objects that are associated with the specific one of the adverse events.

Thereafter, the method includes applying a filter to the selection of infrastructure element objects in order to reduce the selection to a subset of the selection of infrastructure element objects determined to be relevant to the analysis according to the filter. Then, the method includes executing a scenario test of the selection of the subset of the infrastructure element objects across a range of the susceptibility values by computing an average of the susceptibility values for each of the infrastructure element objects in the subset for randomly selected different degrees of severity of the specific one of the adverse events. As well, the method includes executing a recovery simulation of the infrastructure element objects of the subset across a range of recovery times for each of the infrastructure element objects of the subset by computing an average recovery time for a randomized selection of each of the infrastructure element objects of the subset amongst the range of the recovery times. The average of the susceptibility values is then combined with the average recovery time according to one or more loss value rules in order to produce a loss estimate for the target environment accounting for the hierarchal dependency of different ones of the infrastructure element objects upon other ones of the infrastructure element objects.

In different aspects of the embodiment, the infrastructure element objects additionally each store one or more of the following:
a reference to a prophylactic measure adapted to mitigate the susceptibility values if implemented, and a cost to implement the prophylactic measure, wherein the one or more loss value rules computes a comparison of the loss estimate with and without implementing the prophylactic measure;
a data structure of recovery costs each of the costs mapped to a corresponding one of the recovery times in the range, wherein the one or more loss value rules computes the loss estimate accounting as an aggregation function of the recovery costs in the data structure for the encapsulating infrastructure element object and those others of the infrastructure element objects upon which the encapsulating infrastructure element object depends;
a data structure of operability levels, each of the levels mapped to a corresponding one of the recovery times in the range, the method further comprising determining for each corresponding one of the infrastructure element objects a minimum level of operability required for the target environment and correlating the determined minimum level of operability to one of the recovery times in the range for the corresponding one of the infrastructure element objects.

In another embodiment of the invention, a data processing system is adapted for business continuity simulation. The system includes a host computing platform of one or more computers, each with memory and one or processing units including one or more processing cores. The system also includes a display. Even further, the system includes persistent storage coupled to the host computing platform, that stores therein a scenario repository of different infrastructure element objects for a target environment, each of the objects encapsulating both susceptibility values for different adverse events for different degrees of severity of respective ones of the different adverse events and also recovery times for the different adverse events for the different degrees of severity of the respective ones of the different adverse events. Finally, the system includes a business continuity simulation module.

The module includes computer program instructions enabled while executing in the memory of at least one of the processing units of the host computing platform to establish a communicatively linkage to the scenario repository, to query the scenario repository for a specific one of the adverse events and to retrieve in response to the querying, a selection of the infrastructure element objects that are associated with the specific one of the adverse events. The program instructions additionally first execute a scenario test of the selection of the infrastructure element objects across a range of the susceptibility values by computing an average of the susceptibility values for each of the selection of the infrastructure element objects for different degrees of severity of the specific one of the adverse events. The program instructions then second execute a recovery simulation of the infrastructure element objects across a range of recovery times for each of the infrastructure element objects by computing an average recovery time for each of the infrastructure element objects amongst the range of the recovery times. Finally, the program instructions apply one or more loss value rules to the scenario tested and recovery simulated infrastructure element objects to produce a loss estimate for the target environment and display the loss estimate in the display of the host computing platform.

In this way, the technical deficiencies of business continuity planning are overcome owing to the application of the loss value rules to the scenario tested and recovery simulated dependency hierarchy of infrastructure element objects in order to produce a loss estimate for the target environment. Specifically, the scenario testing and recovery simulations across a wide range of event severities permits business continuity planning despite the varying recovery times resulting from the varying severities. In parallel, the application of the loss value rules upon the simulated recovery times allow for the acceptability in some circumstances by an organization of some loss associated with a range of recovery times and the corresponding costs to recovery.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of business continuity simulation;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for business continuity simulation. In accordance with an embodiment of the invention, a scenario repository stores different infrastructure element objects for a target environment. Each of the objects encapsulates different data members including both susceptibility values for different adverse events for different degrees of severity of respective ones of the different adverse events, and also recovery times for the different adverse events for the different degrees of severity of the respective ones of the different adverse events. A communicative connection can be established and thereafter, the repository can be queried for a specific adverse event. In response the query, a selection of the infrastructure element objects associated with the specific adverse event can be retrieved into a simulator.

Optionally, the selection of the infrastructure element objects can be reduced according to a filter such as a filter specifying a minimum event severity or minimum recovery time or minimum cost of impact responsive to an adverse event in order to be subjected to simulation. The simulator then executes a scenario test of the filtered selection of the infrastructure element objects across a range of the susceptibility values by computing an average of the susceptibility values for each of the selection of the infrastructure element objects for randomly selected ones of the different degrees of severity of the specific one of the adverse events. Thereafter, the simulator executes a recovery simulation of the filtered selection of the infrastructure element objects across a range of recovery times for each of the infrastructure element objects by computing an average recovery time for each of the infrastructure element objects in the filtered selection amongst the range of the recovery times. Finally one or more loss value rules are applied to the scenario tested and recovery simulated infrastructure element objects in order to produce a loss estimate for the target environment.

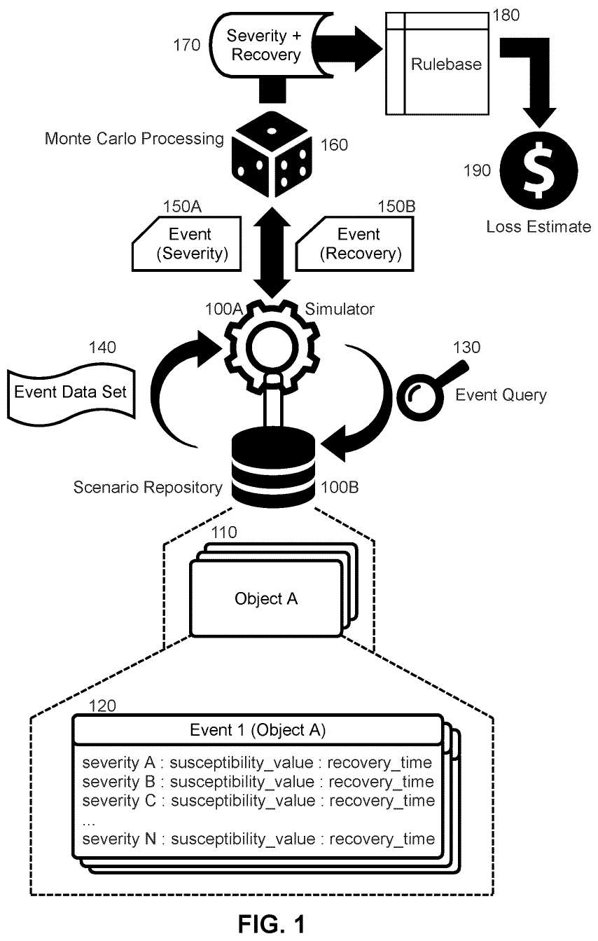

In illustration of one aspect of the embodiment, FIG. 1 pictorially shows a process of business continuity simulation. As shown in FIG. 1, a scenario repository 100B accessed by a simulator 100A stores therein different infrastructure objects 110, each describing a different infrastructure element of a target environment. Each corresponding of the infrastructure objects 110 includes one or more adverse event artifacts 120 each associated with a specific adverse event and each storing therein data members correlating the susceptibility of the infrastructure element of the corresponding one of the infrastructure objects 110 to a particular degree of severity of the associated adverse event. In addition, each of the adverse event artifacts 120 includes data members defining an expected recovery time to the associated adverse event correlated to the particular degree of severity.

In operation, an event query 130 can be issued from the simulator 100A to the scenario repository 100B for a specific adverse event in response to which the scenario repository 100B returns an event data set 140 of the objects 110A prospectively impacted by the specific adverse event as recorded within the objects 110A. Optionally, the objects 110A are then subjected to a filter limiting simulation to only those of the objects 110A impacted by the specific adverse event beyond a threshold impact. The simulator 100A then subjects a randomly select grouping 150A of the data members of the filtered ones of the object 110A for different susceptibility values in objects 110 of the event data set 140 to Monte Carlo processing 160 in order to compute a potential severity of impact of the specific adverse event upon the infrastructure elements of the target environment represented by the objects 110 of the event data set 140. As well, the simulator 100A subjects a randomly select grouping 150B of the data members of the filtered set of the objects 110A for different recovery times in the objects 110 of the event data set 140 to Monte Carlo processing 160 in order to compute a potential recovery time from the specific adverse event for the infrastructure elements of the target environment represented by the objects 110 of the event data set 140.

The result is a combination 170 of prospective severity of impact and potential recovery time which the simulator 100A then submits to a rule base 180 of one or more rules, the rules each defining a loss estimate 190 in terms of an expected cost of the severity of the impact of the specific adverse event during the period of time defined by the recovery time. Optionally, the objects 110 each additionally store a reference to a prophylactic measure adapted to mitigate the susceptibility values if implemented, and a cost to implement the prophylactic measure. In this way, the rules of the rule base 180 compute a comparison of the loss estimate 190 with and without implementing the prophylactic measure.

In another aspect of the embodiment the objects 110 each additionally store a data structure of recovery costs. In this aspect, each of the costs are mapped to a corresponding one of the recovery times in a range of recovery times, so that one or more of the rules of the rule base 180 compute the loss estimate 190 as a function of the recovery costs in the data structure. In yet another aspect of the embodiment, the objects 110 each additionally store a data structure of operability levels. In this aspect, each of the levels are mapped to a corresponding one of the recovery times in the range. In this way, the simulator 100A can determine for each corresponding one of the objects 110 a minimum level of operability required for the target environment and can correlate the determined minimum level of operability to one of the recovery times in the range for the corresponding one of the objects 110.

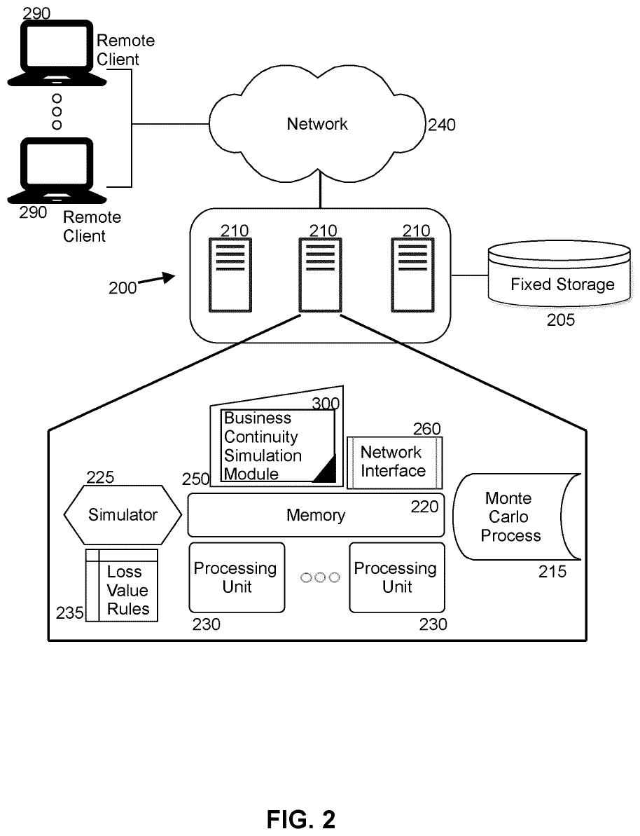

Aspects of the process described in connection with FIG. 1 can be implemented within a data processing system. In further illustration, FIG. 2 schematically shows a data processing system adapted to perform for business continuity simulation. In the data processing system illustrated in FIG. 1, a host computing platform 200 is provided. The host computing platform 200 includes one or more computers 210, each with memory 220 and one or more processing units 230. Different remote clients 290 access computer programmatic logic executing in the host computing platform 200 from over the data communications network 240. The computers 210 of the host computing platform 200 (only a single computer shown for the purpose of illustrative simplicity) can be co-located within one another and in communication with one another over a local area network, or over a data communications bus, or the computers can be remotely disposed from one another and in communication with one another through network interface 260 over the data communications network 240.

The host computing platform includes fixed storage 205. Fixed storage 205 stores therein a scenario repository of different infrastructure element objects for a target environment. Each object encapsulates data members including both susceptibility values for different adverse events for different degrees of severity of respective ones of the different adverse events, and also recovery times for the different adverse events for the different degrees of severity of the respective ones of the different adverse events. Optionally, each object additionally stores a reference to a prophylactic measure adapted to mitigate the susceptibility values if implemented, and a cost to implement the prophylactic measure. As another option, each object additionally stores a data structure of recovery costs each mapped to a corresponding one of the recovery times in a range of recovery times. As yet another option, each object additionally stores a data structure of operability levels, each mapped to a corresponding recovery time in the range.

A simulator 225 is disposed in the memory 220 and during operation, simulates an impact of an adverse event upon one or more infrastructure elements of a target environment by specifying a particular adverse event, identifying the objects in the repository referencing the particular adverse event and determining a loss estimate in the target environment resulting from the occurrence of the particular adverse event according to different loss value rules of a rule base 235. In this regard, the loss value rules of the rule base 235 each define a loss estimate in terms of an expected cost of the severity of the impact of the specific adverse event during the period of time defined by the recovery time.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for business continuity simulation. Specifically, the program instructions during execution receive from the simulator 225 a specified adverse event and to retrieve from the repository of the fixed storage 205 a set of objects known to be impacted by the specified adverse event.

The program instructions then randomly select a grouping of data members for different susceptibility values in the objects of the set to a Monte Carlo process 215 defined in the memory 220 in order to compute a potential severity of impact of the specified adverse event upon the infrastructure elements of the target environment represented by the objects of the set. As well, the program instructions randomly select a grouping of the data members for different recovery times in the objects of the set to the Monte Carlo process 215 in order to compute a potential recovery time from the specific adverse event for the infrastructure elements of the target environment represented by the objects of the set.

The result is a combination of prospective severity of impact and potential recovery time which the program instructions submit to the rule base 235. Optionally, the program instructions apply one or more of the rules of the rule base 235 to compute a comparison of the loss estimate with and without implementing a recorded prophylactic measure. As another option, the program instructions apply one or more of the rules of the rule base 235 to compute the loss estimate as a function of the recovery costs in the data structure. As yet another option, the program instructions determine for each corresponding object a minimum level of operability required for the target environment and correlate the determined minimum level of operability to one of the recovery times in the range for the corresponding object.

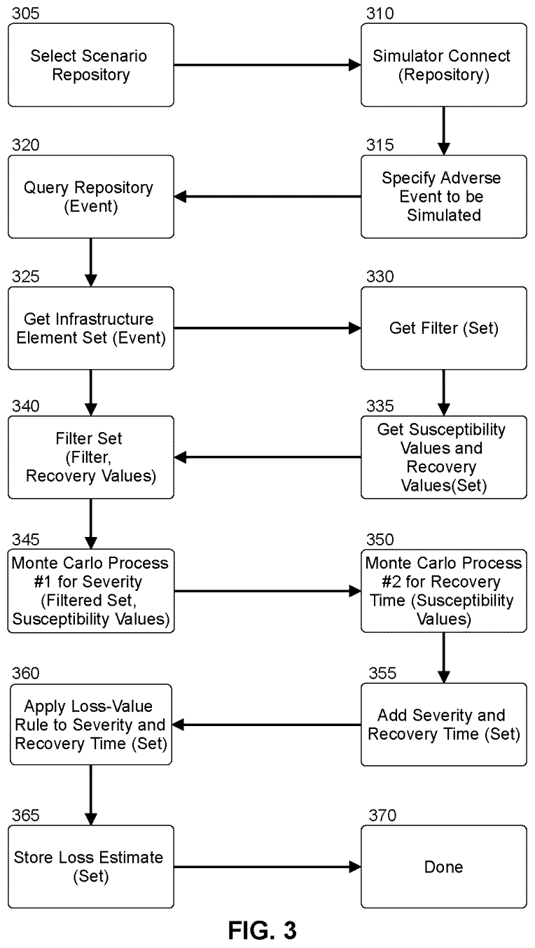

In further illustration of an exemplary operation of the module, FIG. 3 is a flow chart illustrating one of the aspects of the process of FIG. 1. Beginning in block 305, a scenario repository is selected and in block 310, the simulator connects to a scenario repository. In block 315, a specific adverse event is specified in the simulator and in block 320, the scenario repository is queried according to the specific adverse event in order to retrieve in block 325 a set of objects reflective of different infrastructure elements of a target environment exposed to an impact of varying degrees of severity from the occurrence of the specific adverse event.

In block 330, a filter is retrieved for the set of objects indicating any one or more of a minimum impact in recovery time necessary for any one of the infrastructure elements of the objects in the set to be considered relevant for the simulation. As such, in block 335, the susceptibility values and recovery values for each of the objects in the set are retrieved and in block 340, the filter is applied to the recovery values in order to produce a subset of objects with corresponding infrastructure elements reflective of the minimum impact to be considered relevant for the analysis.

Continuing with the subset of objects, in block 345, a random selection of different records corresponding to different susceptibility values are extracted from the objects of the subset and submitted to Monte Carlo processing in order to produce a prediction of severity of impact upon the element resulting from the specific adverse event. Likewise, in block 350, the random selection is submitted to Monte Carlo processing in order to produce a prediction of recovery time for the objects in the subset resulting from the specific adverse event.

Thereafter, in block 355 both the predicted severity of impact and the predicted recovery time are added to a record for the set of infrastructure elements of the objects in the subset and in block 360, a loss value rule is selected and applied to the severity and recovery predictions for the set of infrastructure elements of the objects in the subset in order to compute a loss estimate for the target environment resulting from the occurrence of the specified adverse event at the predicted degree of severity accounting for the predicted recovery time. Finally, in block 365 the computed loss estimate is stored in connection with the set of elements impacted by the specified adverse event. In block 370 the process ends.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A simulation method for business continuity comprising:
executing a simulator in memory of a host data processing system;
establishing a communicative linkage over a computer communications network between the simulator and a scenario repository storing therein different infrastructure element objects for a target environment, each of the objects encapsulating different data members including both susceptibility values for different adverse events for different degrees of severity of respective ones of the different adverse events, and also recovery times for the different adverse events for the different degrees of severity of the respective ones of the different adverse events;
querying the scenario repository for a specific one of the adverse events and in response to the querying, retrieving into the simulator a selection of the infrastructure element objects that are associated with the specific one of the adverse events;
first executing a scenario test of the selection of the infrastructure element objects across a range of the susceptibility values by computing an average of the susceptibility values for each of the selection of the infrastructure element objects for randomly selected ones of the different degrees of severity of the specific one of the adverse events;
second executing a recovery simulation of the infrastructure element objects across a range of recovery times for each of the infrastructure element objects by computing an average recovery time for each of the infrastructure element objects amongst the range of the recovery times; and,
applying one or more loss value rules to the scenario tested and recovery simulated infrastructure element objects to produce a loss estimate for the target environment.

2. The method of claim 1, wherein the infrastructure element objects additionally each store a reference to a prophylactic measure adapted to mitigate the susceptibility values if implemented, and a cost to implement the prophylactic measure, wherein the one or more loss value rules computes a comparison of the loss estimate with and without implementing the prophylactic measure.

3. The method of claim 1, wherein the infrastructure element objects additionally each store a data structure of recovery costs each of the costs mapped to a corresponding one of the recovery times in the range, wherein the one or more loss value rules computes the loss estimate accounting as a function of the recovery costs in the data structure.

4. The method of claim 1, wherein the infrastructure element objects additionally each store a data structure of operability levels, each of the levels mapped to a corresponding one of the recovery times in the range, the method further comprising determining for each corresponding one of the infrastructure element objects a minimum level of operability required for the target environment and correlating the determined minimum level of operability to one of the recovery times in the range for the corresponding one of the infrastructure element objects.

5. A data processing system adapted for business continuity simulation, the system comprising:
a host computing platform comprising one or more computers, each with memory and one or processing units including one or more processing cores;
a display;
a simulator;
persistent storage coupled to the host computing platform, the persistent storage storing therein a scenario repository of different infrastructure element objects for a target environment, each of the objects encapsulating data members including both susceptibility values for different adverse events for different degrees of severity of respective ones of the different adverse events and also recovery times for the different adverse events for the different degrees of severity of the respective ones of the different adverse events; and,
a business continuity simulation module included as part of the simulator, the module comprising computer program instructions enabled while executing in the memory of at least one of the processing units of the host computing platform to perform:
establishing a communicatively linkage between the simulator and the scenario repository;
querying the scenario repository for a specific one of the adverse events and retrieving into the simulator in response to the querying, a selection of the infrastructure element objects that are associated with the specific one of the adverse events;
first executing a scenario test of the selection of the infrastructure element objects across a range of the susceptibility values by computing an average of the susceptibility values for each of the selection of the infrastructure element objects for randomly selected ones of the different degrees of severity of the specific one of the adverse events;
second executing a recovery simulation of the infrastructure element objects across a range of recovery times for each of the infrastructure element objects by computing an average recovery time for each of the infrastructure element objects amongst the range of the recovery times;
applying one or more loss value rules to the scenario tested and recovery simulated infrastructure element objects to produce a loss estimate for the target environment; and,
displaying the loss estimate in the simulator onto the display of the host computing platform.

6. The system of claim 5, wherein the infrastructure element objects additionally each store a reference to a prophylactic measure adapted to mitigate the susceptibility values if implemented, and a cost to implement the prophylactic measure, wherein the one or more loss value rules computes a comparison of the loss estimate with and without implementing the prophylactic measure.

7. The system of claim 5, wherein the infrastructure element objects additionally each store a data structure of recovery costs each of the costs mapped to a corresponding one of the recovery times in the range, wherein the one or more loss value rules computes the loss estimate accounting as a function of the recovery costs in the data structure.

8. The system of claim 1, wherein the infrastructure element objects additionally each store a data structure of operability levels, each of the levels mapped to a corresponding one of the recovery times in the range, the method further comprising determining for each corresponding one of the infrastructure element objects a minimum level of operability required for the target environment and correlating the determined minimum level of operability to one of the recovery times in the range for the corresponding one of the infrastructure element objects.

9. A computing device comprising a non-transitory computer readable storage medium having program instructions stored therein, the instructions being executable by at least one processing core of a processing unit to cause the processing unit to perform a method for business continuity simulation by:
establishing a communicatively linkage over a computer communications network to a scenario repository storing therein different infrastructure element objects for a target environment, each of the objects encapsulating both susceptibility values for different adverse events for different degrees of severity of respective ones of the different adverse events and also recovery times for the different adverse events for the different degrees of severity of the respective ones of the different adverse events;
querying the scenario repository for a specific one of the adverse events and retrieving in response to the querying, a selection of the infrastructure element objects that are associated with the specific one of the adverse events;
first executing a scenario test of the selection of the infrastructure element objects across a range of the susceptibility values by computing an average of the susceptibility values for each of the selection of the infrastructure element objects for randomly selected ones of the different degrees of severity of the specific one of the adverse events;
second executing a recovery simulation of the infrastructure element objects across a range of recovery times for each of the infrastructure element objects by computing an average recovery time for each of the infrastructure element objects amongst the range of the recovery times; and,
applying one or more loss value rules to the scenario tested and recovery simulated infrastructure element objects to produce a loss estimate for the target environment.

10. The device of claim 9, wherein the infrastructure element objects additionally each store a reference to a prophylactic measure adapted to mitigate the susceptibility values if implemented, and a cost to implement the prophylactic measure, wherein the one or more loss value rules computes a comparison of the loss estimate with and without implementing the prophylactic measure.

11. The device of claim 9, wherein the infrastructure element objects additionally each store a data structure of recovery costs each of the costs mapped to a corresponding one of the recovery times in the range, wherein the one or more loss value rules computes the loss estimate accounting as a function of the recovery costs in the data structure.

12. The device of claim 9, wherein the infrastructure element objects additionally each store a data structure of operability levels, each of the levels mapped to a corresponding one of the recovery times in the range, the method further comprising determining for each corresponding one of the infrastructure element objects a minimum level of operability required for the target environment and correlating the determined minimum level of operability to one of the recovery times in the range for the corresponding one of the infrastructure element objects.
